(19) United States
(12) Patent Application Publication
(10) Pub. No.: US 2004/0128683 A1
(43) Pub. Date: Jul. 1, 2004

(54) Apparatus and method for displaying electronic program guide

(75) Inventor: Chang-Seog Ko, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMAUNG ELECTRONICS CO., LTD.

(21) Appl. No.: 10/633,706

(22) Filed: Aug. 5, 2003

(30) Foreign Application Priority Data
Dec. 31, 2002 (KR) 2002-87937

(51) Int. Cl. G06F 13/00

(52) U.S. Cl. 725/39

(57) ABSTRACT

An electronic program guide display apparatus and method are provided. The electronic program guide display apparatus includes: a program information receiving unit which receives program information about electronic program guide organization programs from a broadcast station; a program information database which stores the received program information; a mode information input unit which receives mode information from a user; a day information input unit which receives day information from a user; a program cell display unit which extracts program information corresponding to a mode which the mode information indicates and a day which the day information indicates, from the program information in the database, and displays the extracted program information as cells having a uniform format, regardless of a predetermined characteristic of the program information. According to the electronic program guide display apparatus and method, it is possible for a viewer to see at a glance a program cell, thereby improving readability of program information.

### BACKGROUND OF THE INVENTION

This application claims priority from Korean Patent Application No. 2002-87937, filed on Dec. 31, 2002, in the Korean Intellectual Property Office, the disclosure of which is incorporated herein in its entirety by reference.

1. Field of the Invention

The present invention relates to an apparatus and method for displaying an electronic program guide.

2. Description of the Related Art

FIG. 1 is a view illustrating a conventional electronic program guide.

An Electronic Program Guide (EPG) is a broadcast program schedule which is displayed on a screen through a data broadcast using frequency bands or channels that are empty in a digital broadcast. Such an electronic program guide allows viewers to obtain channel information easily, by classifying preview programs or program-related information received from a plurality of broadcasting stations according to subjects, time slots, viewer preferences, etc. As shown in FIG. 1, an electronic program guide of a digital TV generally shows broadcast channels on a vertical axis thereof and shows broadcast times on a horizontal axis thereof. However, a problem exists in that the conventional method of displaying the electronic program guide as shown in FIG. 1 is difficult for viewers to take in the electronic program guide at a glance, since broadcast time slots of respective programs are not uniform and thus the sizes and shapes of program cells are also not uniform. That is, the problem is that the readability of the electronic program guide is not good. Also, in the case where a program has a relatively long broadcasting time, the program cell thereof is accordingly larger and thus occupies a larger area on a display picture. For this reason, a problem exists in that within the limits of a screen, information about many other programs cannot be displayed.

### SUMMARY OF THE INVENTION

The present invention provides an apparatus and method for displaying an electronic program guide, capable of providing good readability and displaying plenty of program information on a display picture.

According to an aspect of the present invention, there is provided a program information display apparatus including: a user-selected information input unit which receives user-selected information from a user; and a program cell display unit, which displays the program information corresponding to objects, which the user-selected information input to the user-selected information input unit indicates, as a program cell having a uniform format, regardless of a predetermined characteristic of the program information.

According to another aspect of the present invention, there is provided an electronic program guide display apparatus including: a program information receiving unit which receives program information being information about an electronic program guide organization program from a broadcast station; a program information database which stores the program information received in the program information receiving unit; a mode information input unit which receives mode information about electronic program guide display modes from a user; a day information input unit which receives day information about electronic program guide organization days from a user; and a program cell display unit, which extracts program information corresponding to a mode which the mode information input to the mode information input unit indicates and a day which the day information input to the day information input unit indicates, from the program information stored in the program information database, and displays the extracted program information as a program cell having a uniform format, regardless of a predetermined characteristic of the program information.

According to still another aspect of the present invention, there is provided a program information display method including: (a) receiving user-selected information from a user; and (b) displaying program information corresponding to objects that the received user-selected information indicates, as a program cell having a uniform format, regardless of a predetermined characteristic of the program information.

According to a further aspect of the present invention, there is provided an electronic program guide display method including: (a) receiving program information about electronic program guide organization programs from a broadcast station; (b) storing the received program information; (c) receiving mode information about electronic program guide display modes from a user; and (d) receiving day information about electronic program guide organization days from a user; and (e) extracting program information corresponding to a mode that the received mode information indicates and a day that the received day information indicates, from the stored program information and displaying the extracted program information as cells having a uniform format, regardless of a predetermined characteristic of the program information.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a conventional electronic program guide;

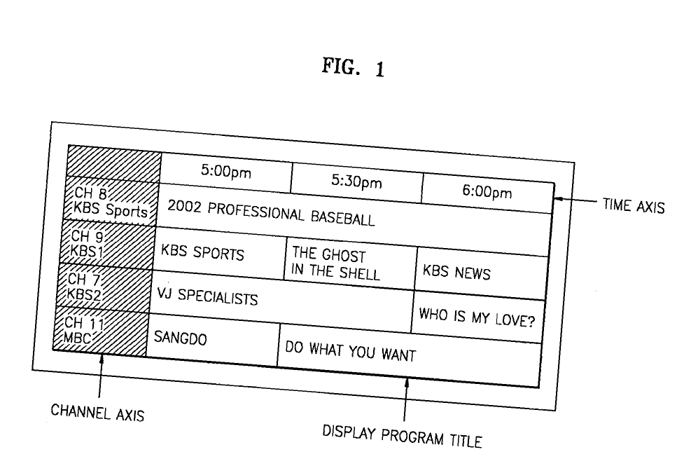

FIG. 2 is a block diagram schematically showing the structure of a program information display apparatus according to an exemplary embodiment of an aspect of the present invention;

FIG. 3 is a block diagram schematically showing the structure of an electronic program guide display apparatus according to an exemplary embodiment of another aspect of the present invention;

FIG. 4 is a view illustrating an initial picture displayed by the electronic program guide display apparatus of FIG. 3;

FIG. 5 is a view illustrating an example of inputting setting information on the picture displayed by the electronic program guide display apparatus of FIG. 3;

FIG. 6 is a view illustrating an example of inputting type information on the picture displayed by the electronic program guide display apparatus of FIG. 3;

FIG. 7 is a view illustrating an example of inputting day information using the picture displayed by the electronic program guide display apparatus of FIG. 3;

FIG. 8 is a flow chart illustrating an electronic program information display method according to an exemplary embodiment of still another aspect of the present invention; and

FIG. 9 is a flow chart illustrating an electronic program guide display method according to a preferred embodiment of yet another aspect of the present invention.

### DETAILED DESCRIPTION OF THE INVENTION

Hereinafter, exemplary embodiments of the present invention will be described in detail with reference to the appended drawings.

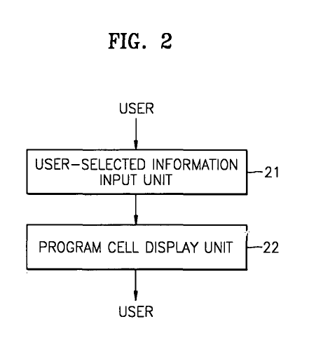

FIG. 2 is a block diagram schematically showing the structure of a program information display apparatus according to a preferred embodiment of an aspect of the present invention.

The program information display unit includes a user-selected information input unit 21 and a program cell display unit 22.

The user-selected information input unit 21 receives user-selected information from a user. Here, the user-selected information includes mode information about display modes, day information about broadcast days, etc. When information about programs is displayed on a screen, the extent to which the information will be displayed should be selected by the user. For example, program titles can merely be displayed, or in more detail, the program titles, the broadcast times of the programs, viewer age restriction of the programs, whether the programs are charged or not-charged, etc. can be displayed. When the information about programs is displayed on the screen, the day of the week whose program information is to be displayed should also be selected by the user.

The program cell display unit 22 displays program information corresponding to objects, which the user-selected information input to the user-selected information input unit 21 indicates, as a program cell having a uniform format. The program cell has the uniform format regardless of a predetermined characteristic of the program information. Here, the program information includes program title information, broadcast time information, viewer age restriction information, pay-per-view information, etc., and the characteristic of the program information stands for the length of the broadcast. Accordingly, the program cell has the uniform format (for example, a rectangular shape of the same size), regardless of the length of the broadcast, contrary to the conventional technique. That is, the program information according to the mode information and day information being the user-selected information, are displayed as the program cell. Because the program cell having the same sizes and shapes correspond one-to-one to the respective programs, the user can easily view them. Even though the user selects a mode which displays all information of the program, all of the information is displayed in one program cell, thereby allowing much information to be displayed on one screen.

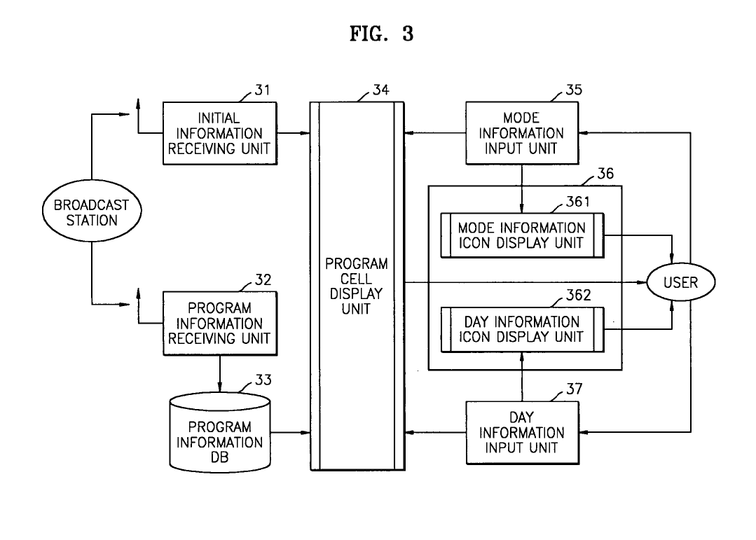

FIG. 3 is a block diagram schematically showing the structure of an electronic program guide display apparatus according to an exemplary embodiment of another aspect of the present invention.

The electronic program guide display apparatus comprises a program information receiving unit 32, a program information database 33, a mode information input unit 35, a day information input unit 37, a program cell display unit 34, an initial information receiving unit 31, a mode information icon display unit 361, and a day information icon display unit 362.

The program information receiving unit 32 receives program information about electronic program guide organization programs from a broadcast station. Generally, the broadcast station updates and transmits program information of a week, every week. In each household, the program information is received through a terminal capable of receiving program information that is digital data, that is, a digital TV (for example, HDTV), etc. Here, the program information includes program title information, broadcast time information, viewer age restriction information, pay-per-view information, etc., and a characteristic of the program information that indicates the length of the broadcast.

The program information database 33 stores program information received in the program information receiving unit 32. To display an electronic program guide according to a viewer's preference on a screen, only program information the viewer wants to see are extracted from all program information, are stored in a storage medium such as a hard disc, and then displayed on the screen.

The mode information input unit 35 receives mode information about electronic program guide display modes from a user. Generally, the user sees various modes displayed on the screen and selects any one mode among the modes, using a remote control of the digital TV. Such modes include a mode for displaying all program information in detail, a mode for displaying only basic program information, etc. When displaying only the basic program information, it is possible to reduce the size of a program cell and display program information of many channels since the amount of the contents to be included in the program cell is small. When an interactive TV is generalized in the future, the mode information may be input using a mouse or touch screen as in a current PC environment. Here, the mode information is subdivided into setting information of program information and type information of program information. The setting information indicates a display-on setting or display-off setting for displaying or not displaying the respective program information, and the type information indicates drama, news, sports, or movies, etc., as a display basis for the respective program information. That is, the setting information determines what to be displayed or what not to be displayed on the screen, among the program title information, the broadcast time information, the viewer age restriction information, the pay-per-view information, etc., all of which are program information. Also, the type information determines whether to display all program information, whether to extract and display only drama among the program information, or whether to extract and display only news among the program information, etc.

The day information input unit 37 receives day information about electronic program guide organization days from a user. Like the mode information input unit 35, the user can see various days displayed on the screen and select any one day among the days, using the remote control of the HDTV, and can further select a day using the mouse or touch screen as in the current PC environment when the interactive TV is generalized in the future. Generally, when a day is selected and displayed, a date corresponding to the day is also displayed. The program information can be displayed on the screen in accordance with a clock installed in the digital TV or synchronizing with a clock of the broadcast station while periodically receiving a current date and time from the broadcast station. Here, the day information may indicate a day of a week or an entire week.

The program cell display unit 34 extracts program information corresponding to a mode, which the mode information input into the mode information input unit 35 indicates, and a day, which the day information input to the day information input unit 37 indicates, and displays the extracted program information as cells having a uniform format, regardless of the predetermined characteristic of the extracted program information. That is, because the mode and day are dependent on the user's selection, only the user-selected program information is extracted from the program information stored in the program information database 33 and displayed as the program cells. As described above, the program cell has the uniform format (for example, a rectangular shape of the same size), regardless of the length of the broadcast, etc. corresponding to the characteristic of the program information.

If the mode information input to the mode information input unit 35 is the setting information indicating the display-on setting or display-off setting for the respective program information, the program cell display unit 34 extracts program information corresponding to the display-on setting, which the setting information indicates from the program information stored in the program information database 33, and displays the extracted program information as a program cell. If the mode information input to the mode information input unit 35 is the type information indicating drama, news, sports, movies, or all of these as the display basis for the respective program information, the program cell display unit 34 extracts program information corresponding to the type, which the type information indicates, from the program information stored in the program information database 33, and displays the extracted program information as a program cell. If the day information input to the day information input unit 37 indicates the entire week, the program cell display unit 34 extracts program information corresponding to the entire week from the program information stored in the program information database and displays the extracted program information as a program cell.

The initial information receiving unit 31 receives initial information including current day information and current time information from the broadcast station. When any mode information or any day information is not yet input from a user right after the digital TV is turned on, only the program information corresponding to that specific day, that is, the current day designated in the digital TV system, is extracted and displayed on the screen. Accordingly, the initial information including the current day information and current time information should be received from the broadcast station immediately after the digital TV is turned on. That is, when no mode information is input to the mode information input unit 35 and no day information is input to the day information input unit 37, the program cell display unit 34 extracts program information corresponding to the day which the current day information indicates, a mode which the basic mode information designated as a default in the digital TV system indicates, and initial information received in the initial information receiving unit 31, from the program information stored in the program information database 33, and displays the extracted program information as a program cell. Here, the program cell display unit 34 displays the program information corresponding to a timepoint indicated by the current time information among the extracted program information and among the initial information received in the initial information receiving unit 31, as the left most program cell of the displayed program cells.

While the user searches a program cell using the remote control and the like, there are cases where he/she wants to return to the initial picture upon turning on the DTV. At this time, the user presses an initial picture restoration button of the remote control to input an initial picture restoration command. When the initial picture restoration command is input from the user, the program cell display unit 34 extracts the program information corresponding to the mode indicated by the basic mode information and the day indicated by the current day information, from the program information stored in the program information database 33 and displays the extracted information as a program cell.

The mode and day information display unit 36 displays the mode information and day information of the electronic program guide displayed on the current screen for the user. The mode and day information display unit 36 is subdivided into the mode information icon display unit 361 and the day information icon display unit 362. The mode information icon display unit 361 displays the mode information respectively as icons for the user and displays the icon corresponding to the mode which the mode information input to the mode information input unit 35 indicates in such a manner that the icon is distinguished from other icons. The day information icon display unit 362 displays the day information respectively as icons for the user and displays the icon corresponding to the day which the day information input to the day information input unit indicates in such a manner that the icon is distinguished from other icons. A method of displaying the selected icon to be distinguished from the other icons may be to display the currently selected icon brighter or darker than other icons.

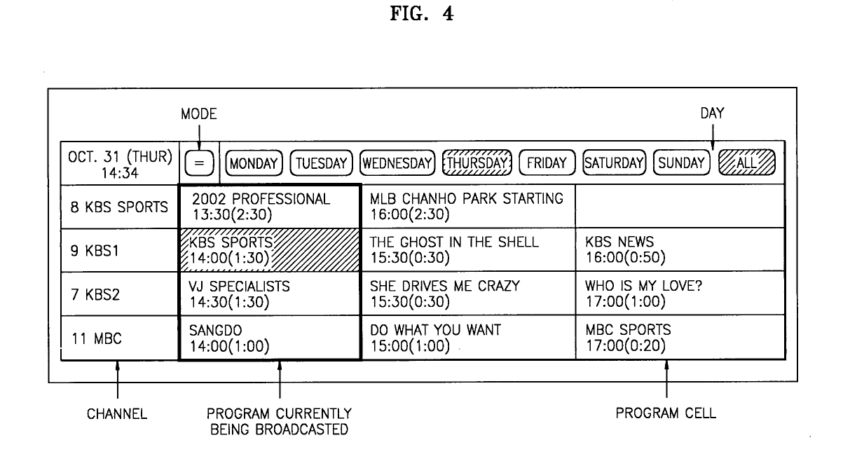

FIG. 4 is a view illustrating an initial picture displayed by the electronic program guide display apparatus of FIG. 3.

As described above, when no mode information or no day information is input from a user after the digital TV is turned on, only the mode designated in the internal system of the digital TV and the program information corresponding to that specific day are extracted and displayed on the screen. That is, when no mode information is input to the mode information input unit 35 and no day information is input to the day information input unit 37, the program cell display unit 34 extracts the program information corresponding to the mode indicated by the basic mode information and the day indicated by the current day information from the program information stored in the program information database 33, and displays the extracted program information as a program cell. In a case of the electronic program guide shown in FIG. 4, the mode information is the setting information, the program titles and the broadcast times are set as the display-on state, and other program information is set as the display-off state.

As shown in FIG. 4, in the case of the initial picture, programs currently being broadcasted are displayed as the left most program cell. That is, the program cell display unit 34 displays the program information corresponding to the timepoint indicated by the current time information among the extracted program information and among the initial information received in the initial information receiving unit 31, as the left most program cell. At this time, the program cell for the program currently being broadcasted is displayed as another background color or another icon to distinguish it from other program cells. As described above, when the user presses the initial picture restoration button and inputs the initial picture restoration command, the picture returns to the initial picture. That is, the program information corresponding to the mode which the basic mode information indicates and the day which the current day information indicates are extracted, and the extracted program information are displayed as a program cell.

As shown in FIG. 4, the broadcast time may be represented as a beginning time and a length of the broadcast or as the beginning time and an ending time.

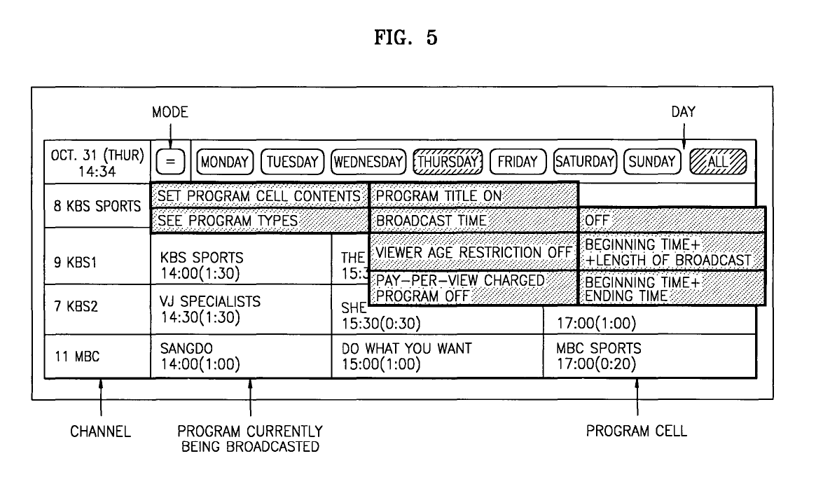

FIG. 5 is a view illustrating an example of inputting the setting information on the picture displayed by the electronic program guide display apparatus of FIG. 3.

As shown above, when the mode information input to the mode information input unit 35 is the setting information indicating the display-on setting or display-off setting for the respective program information, the program cell display unit 34 extracts the program information corresponding to any display-on setting indicated by the setting information from the program information stored in the program information database 33 and displays the extracted information as a program cell. In the case of the electronic program guide shown in the drawing, when the setting information or type information is selected for the mode information; the program title information, the broadcast time information, the viewer age restriction information, and the pay-per-view information is selected for the setting information; and the beginning time and length of the broadcast (represented as an icon of the “beginning time+length of the broadcast” on the screen) and the beginning time+ending time is selected for the broadcast time information. As shown in FIG. 4, to provide a GUI (Graphical User Interface) environment for facilitating the user's understanding, the mode information icon display unit 361 displays the respective mode information as icons for the user, and displays the icon corresponding to the mode that the mode information input by the user indicates, brighter than other icons to distinguish it from the other icons. If the user selects a particular icon and inputs mode information, the electronic program guide screen is updated in real time according to the information. That is, when the user tries to select the setting information, he/she should click an icon to set the contents of a program cell on the screen. When the user tries to select the broadcast time information, he/she should click an icon for the broadcast time on the screen. When the user tries to select the length of the broadcast, he/she should click an icon for the beginning time+length of the broadcast on the screen.

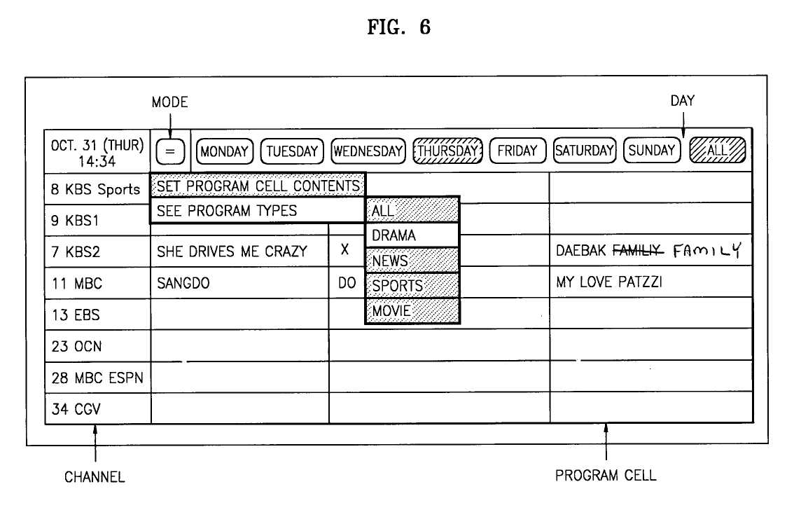

FIG. 6 is a view illustrating an example of inputting the type information on the picture displayed by the electronic program guide display apparatus of FIG. 3.

As described above, when the mode information input to the mode information input unit 35 is the type information indicating drama, news, sports, movies, or all, as the display basis of the respective program information, the program cell display unit 34 extracts the program information corresponding to the type indicated by the type information from the program information stored in the program information database 33 and displays the extracted program information as a program cell. In the case of the electronic program guide shown in FIG. 6, the type information among the setting information or type information is selected for the mode information, and drama among drama, news, sports, movies, or all is selected for the type information. Accordingly, only the information about the programs classified as drama is displayed on the screen. That is, when the user tries to select the type information, he/she should click an icon for showing program types on the screen. When the user tries to select drama, he/she should click an icon for drama on the screen.

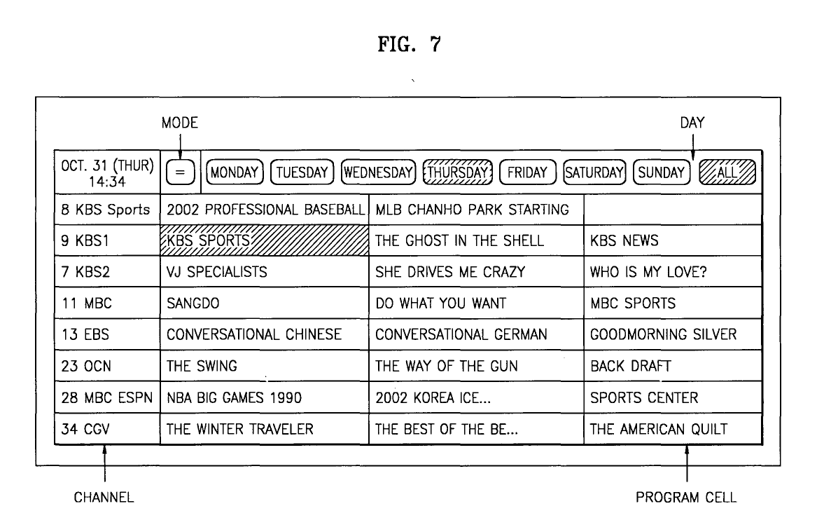

FIG. 7 is a view illustrating an example of inputting the day information on the picture displayed by the electronic program guide display apparatus of FIG. 3.

As described above, when the day information input to the day information input unit 37 indicates the entire week, the program cell display unit 34 extracts the program information corresponding to the entire week from the program information stored in the program information database, and displays the extracted program information as a program cell. In the case of the electronic program guide shown in FIG. 7, a day of a week out of an entire week or an entire week is selected for the day information. As shown in FIG. 7, to provide a GUI environment for facilitating the user's understanding, the day information icon display unit 362 displays the respective day information as icons for the user and displays the icon corresponding to the day, which the day information input to the day information input unit indicates, brighter than other icons to distinguish it from the other icons. If the user selects a particular icon and inputs the day information, the electronic program guide picture is updated in real time according to the information. That is, when a user tries to select the entire week, he/she should click the “ALL” icon on the screen. FIG. 7 shows the state where only the program titles are clicked to the display-on state in the mode information icon display unit and the remaining are clicked to the display-off state, at the same time that “ALL” is clicked in the day information icon display unit. Also, it is seen that FIG. 7 is an initial screen just after the digital TV is turned on or just after the initial picture restoration command is input, seeing that the currently broadcasting programs are displayed as the left most program cell.

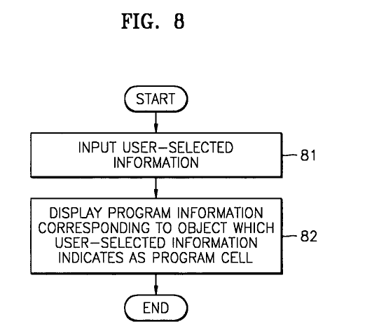

FIG. 8 is a flow chart illustrating an electronic program information display method according to a preferred embodiment of still another aspect of the present invention.

First, user-selected information is received from a user (step 81). Then, program information corresponding to objects, which the received user-selected information indicates, are displayed as a program cell having a uniform format, regardless of a predetermined characteristic of the program information. Here, the user-selected information includes mode information about display modes, day information about broadcast days, etc. The program information includes program title information, broadcast time information, viewer age restriction information, and pay-per-view information, etc. and the characteristic of the program information that corresponds to the length of the broadcast.

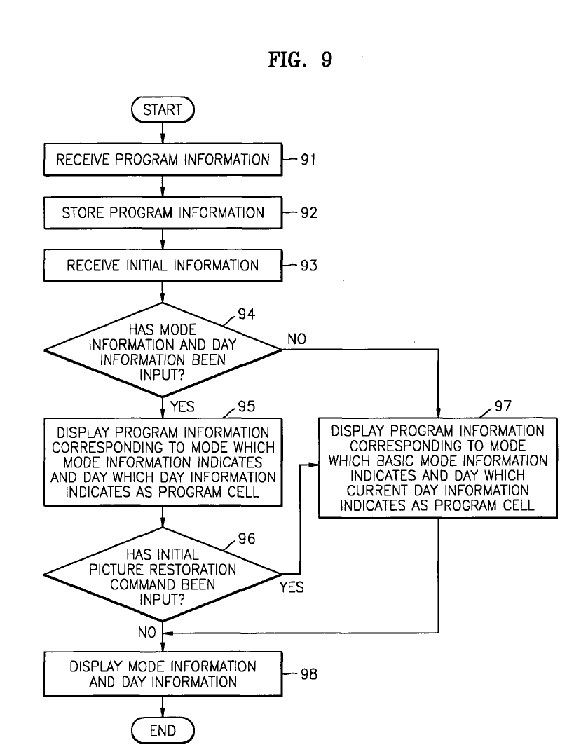

FIG. 9 is a flow chart illustrating an electronic program guide display method according to a preferred embodiment of yet another aspect of the present invention.

First, program information about electronic program guide organization programs is received from a broadcast station (step 91). Here, the program information includes program title information, broadcast time information, viewer age restriction information, and pay-per-view information, and the characteristic of the program information, which corresponds to the length of the broadcast. Then, the received program information is stored (step 92). Initial information including basic mode information, current day information, and current time information are received from the broadcast station (step 93). Then, it is determined whether mode information, which is information about the electronic program guide display modes, is received from the user (step 94). Here, the mode information is subdivided into setting information of program information and type information of program information. The setting information indicates a display-on setting or display-off setting for displaying or not displaying the respective program information, and the type information indicates entire, drama, news, sports, movies, or all as a display basis for the respective program information. Also, it is determined whether day information, which is information about the electronic program guide organization days, has been received. Here the day information can indicate a day of a week or an entire week.

When mode information and day information has been input, the program information corresponding to a mode indicated by the input mode information and a day indicated by the input day information are extracted from the stored program information, and the extracted program information is displayed as cells having a uniform format, regardless of the predetermined characteristic of the extracted program information (step 95). When the input mode information is the setting information, the program information corresponding to the display-on setting indicated by the setting information is extracted from the stored program information and displayed as a program cell, and when the input mode information is the type information, the program information corresponding to the type indicated by the type information is extracted from the stored program information and displayed as a program cell. Also, when the received day information indicates the entire week, the program information corresponding to the entire week is extracted from the stored program information and displayed as a program cell.

When no mode information is input and no day information is input (step 94), the program information corresponding to the day indicated by the current day information among the received initial information and the mode indicated by the basic mode information are extracted from the stored program information, and displayed as a program cell. At this time, the program information corresponding to the timepoint indicated by the current time information can be displayed as the left most program cell of the displayed program cells. Also, if the initial picture restoration command is input from a user (step 96), the program information corresponding to the mode indicated by the basic mode information and the day indicated by the current day information are extracted from the stored program information and displayed as a program cell (step 97).

Then, the mode information and day information are displayed for the user (step 98). The mode information is displayed respectively as icons for the user, wherein the icon corresponding to the mode indicated by the input mode information is displayed in a manner to be distinguished from other icons, and the day information is displayed respectively as icons for the user, wherein the icon corresponding to the day indicated by the input day information is displayed in a manner to be distinguished from other icons.

On the other hand, the above-described preferred embodiments may be embodied as computer programs and may also be embodied on a general-purpose digital computer for executing the computer programs using a computer readable medium.

The computer readable medium includes storage media such as magnetic storage media (e.g., ROM's, floppy discs, hard discs, etc.), optically readable media (e.g., CDROMs, DVDs, etc.), and carrier waves (transmissions over the Internet).

According to the present invention, a viewer can view at a glance how broadcast programs are organized by making the sizes and shapes of broadcast program cells the same and displaying program information based on program titles. That is, there is an advantage of improving readability of a program. Also, according to the present invention, there is another advantage of displaying plenty of program information on one screen by removing conventional large cells for the programs having long broadcast time periods.

Further, there is still another advantage of allowing a user to easily find program information corresponding to each day by displaying a day selection area on a horizontal axis, contrary to a conventional technique. Therefore, the present invention is to provide an application which is completely different from the conventional method by removing the time axis on the conventional electronic program guide.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A program information display apparatus comprising:
a user-selected information input unit which receives user-selected information from a user; and
a program cell display unit which displays program information corresponding to objects, which are based on the user-selected information input to the user-selected information input unit, as a program cell having a uniform format, regardless of a predetermined characteristic of the program information.

2. The program information display apparatus of claim 1, wherein the user-selected information includes mode information about display modes and day information about broadcast days, the program information comprises program title information, broadcast time information, viewer age restriction information and pay-per-view information, and the predetermined characteristic of the program information is a length of a broadcast.

3. An electronic program guide display apparatus comprising:
a program information receiving unit which receives program information about electronic program guide organization programs from a broadcast station;
a program information database which stores the program information received in the program information receiving unit;
a mode information input unit which receives mode information about electronic program guide display modes, from a user;
a day information input unit which receives day information about electronic program guide organization days from a user; and
a program cell display unit which extracts program information corresponding to a mode, which is based on the mode information input to the mode information input unit, and a day, which is based on the day information input to the day information input unit, from the program information stored in the program information database and displays the extracted program information as a program cell having a uniform format, regardless of a predetermined characteristic of the program information.

4. The electronic program guide display apparatus of claim 3, further comprising an initial information receiving unit which receives initial information including current day information and current time information from the broadcast station.

5. The electronic program guide display apparatus of claim 4, wherein when no mode information is input to the mode information input unit and no day information is input to the day information input unit, the program cell display unit extracts program information corresponding to a mode indicated by basic mode information and a day indicated by the current day information, from the program information stored in the program information database and displays the extracted program information as the program cell.

6. The electronic program guide display apparatus of claim 5, wherein the program cell display unit displays program information corresponding to a timepoint indicated by the current time information among the extracted program information, based on the initial information received in the initial information receiving unit, as a left most program cell of displayed program cells.

7. The electronic program guide display apparatus of claim 4, wherein when an initial picture restoration command is input from a user, the program cell display unit extracts program information corresponding to a mode indicated by basic mode information and a day indicated by the current day information, from the program information stored in the program information database and displays the extracted program information as the program cell.

8. The electronic program guide display apparatus of claim 3, further comprising a mode information display unit and day information display unit which displays the mode information and the day information for the user.

9. The electronic program guide display apparatus of claim 8, wherein the mode information display unit and the day information display unit comprises:
a mode information icon display unit which displays the mode information respectively as at least one icon for the user and displays an icon corresponding to the mode which the mode information input to the mode information input unit indicates, in such a manner that the icon is distinguished from other icons; and
a day information icon display unit which displays the day information respectively as at least one icon for the user and displays an icon corresponding to a day which the day information input to the day information input unit indicates, in such a manner that the icon is distinguished from other icons.

10. The electronic program guide display apparatus of claim 3, wherein the program information comprises program title information, broadcast time information, viewer age restriction information, and pay-per-view information, and the characteristic of the program information is a length of the broadcast.

11. The electronic program guide display apparatus of claim 3, wherein the mode information includes setting information of the program information and type information of the program information, wherein the setting information indicates one of a display-on setting and display-off setting for the respective program information and the type information indicates one of drama, news, sports, movies and all of the above, as a display basis for the respective program information.

12. The electronic program guide display apparatus of claim 11, wherein when the mode information input to the mode information input unit is the setting information, the program cell display unit extracts program information corresponding to the display-on setting that the setting information indicates, from the program information stored in the program information database and displays the extracted program information as the program cell.

13. The electronic program guide display apparatus of claim 11, wherein when the mode information input to the mode information input unit is the type information, the program cell display unit extracts program information corresponding to the type which the type information indicates, from the program information stored in the program information database and displays the extracted program information as the program cell.

14. The electronic program guide display apparatus of claim 3, wherein the day information indicates one of a day of a week and an entire week.

15. The electronic program guide display apparatus of claim 14, wherein when the day information input to the day information input unit indicates the entire week, the program cell display unit extracts program information corresponding to the entire week from the program information stored in the program information database and displays the extracted program information as the program cell.

16. A program information display method comprising:
(a) receiving user-selected information from a user; and
(b) displaying program information corresponding to objects, which is based on the received user-selected information, as a program cell having a uniform format, regardless of a predetermined characteristic of the program information.

17. The program information display method of claim 16, wherein the user-selected information includes mode information about at least one display mode and day information about at least one broadcast day, the program information includes program title information, broadcast time information, viewer age restriction information, and pay-per-view information, and the predetermined characteristic of the program information is a length of the broadcast.

18. An electronic program guide display method comprising:
(a) receiving program information about at least one electronic program guide organization program from a broadcast station;
(b) storing the received program information;
(c) receiving mode information about at least one electronic program guide display mode from a user; and
(d) receiving day information about at least one electronic program guide organization day from a user; and
(e) extracting program information corresponding to a mode indicated by the received mode information and a day indicated by the received day information, from the stored program information and displaying the extracted program information as cells having a uniform format, regardless of a predetermined characteristic of the program information.

19. The electronic program guide display method of claim 18, further comprising receiving initial information including current day information and current time information from the broadcast station.

20. The electronic program guide display method of claim 19, wherein in the step (e) the program information extracted from the stored program information corresponds to a mode indicated by basic mode information and a day indicated by the current day information, and is displayed as a program cell, when no mode information is input and no day information is received from the user.

21. The electronic program guide display method of claim 20, wherein in the step (e), program information corresponding to a timepoint indicated by the current time information among the extracted program information is displayed, based on the received initial information, as a left most program cell of the displayed program cells.

22. The electronic program guide display method of claim 19, wherein in the step (e), the program information corresponds to a mode indicated by basic mode information and a day indicated by the current day information, and is displayed as a program cell, when an initial picture restoration command is input from the user.

23. The electronic program guide display method of claim 18, further comprising step (f) displaying the mode information and the day information for the user.

24. The electronic program guide display method of claim 23, wherein the step (f) comprises:
(f1) displaying the mode information respectively as icons for the user, and displaying an icon corresponding to the mode which the received mode information indicates in such a manner that the icon is distinguished from other icons; and
(f2) displaying the day information respectively as icons for the user, and displaying an icon corresponding to the day which the received day information indicates in such a manner that the icon is distinguished from other icons.

25. The electronic program guide display method of claim 18, wherein the program information comprises program title information, program time information, viewer age restriction information and pay-per-view information, and the predetermined characteristic of the program information is a length of the broadcast.

26. The electronic program guide display method of claim 18, wherein the mode information comprises setting information related to the program information and type information related to the program information, wherein the setting information indicates one of a display-on setting and display-off setting, for displaying and not displaying the respective program information, and the type information indicates at least one of drama, news, sports, and movies as a display basis for the respective program information.

27. The electronic program guide display method of claim 26, wherein in the step (e), the program information extracted from the stored program information corresponds to the display-on setting which the setting information indicates, and is displayed as a program cell, when the received mode information is the setting information.

28. The electronic program guide display method of claim 26, wherein in the step (e), the program information extracted from the stored program information corresponds to a type which the type information indicates and is displayed as a program cell, when the received mode information is the type information.

29. The electronic program guide display method of claim 18, wherein the received day information indicates one of a day of a week and an entire week.

30. The electronic program guide display method of claim 29, wherein in the step (e), the program information extracted from the stored program information corresponds to the entire week, and is displayed as a program cell, when the received day information indicates the entire week.

31. A computer readable medium having embodied thereon a computer program for a method according to any one of claims 16 through 30.
